(19) United States
(12) Patent Application Publication
(10) Pub. No.: US 2003/0163570 A1
(43) Pub. Date: Aug. 28, 2003

(54) Command line interface session tool

(75) Inventors: Paul M. Hendley, Lancaster, MA (US); Shadrack K. Kilemba, Nashua, NH (US); Andres Perez, Waltham, MA (US); Mike Fitterman, Harvard, MA (US)

Correspondence Address: LAHIVE & COCKFIELD, 28 STATE STREET, BOSTON, MA, 02109, US

(73) Assignee: Sun Microsystems, Inc., Palo Alto, CA

(21) Appl. No.: 10/085,530

(22) Filed: Feb. 26, 2002

(51) Int. Cl. G06F 15/16

(52) U.S. Cl. 709/227

(57) ABSTRACT

A method and apparatus relating to a CLI session tool that works in the HTTP environment of web-based applications is provided. The CLI session tool has a pre-defined set of base commands and allows a user to dynamically add their own commands to the CLI session tool. In accordance with one example embodiment, in an electronic server device in communication with a network, a method is provided for interacting with an application or database. The method includes receiving a request for information from a command line interface client. The request is mapped to a server side component, such as an instance of an action class. The action class instance queries the application or database for the information requested by the command line interface client. The action class instance then instructs a controller servlet to select and use a server page to construct an outgoing user interface. The server page constructs the outgoing user interface and sends the information requested to the command line interface client, such that the command line interface client can present a user with the information requested.

### RELATED APPLICATION

This application relates to co-pending U.S. patent application Ser. No. ______, filed ______, (Attorney Docket SMQ-083) and U.S. patent application Ser. No. ______, filed ______, (Attorney Docket SMQ-084) which are expressly and entirely incorporated herein by reference.

### FIELD OF THE INVENTION

The present invention relates generally system management and more particularly to a command line interface (CLI) session tool providing a set of base commands and allowing the dynamic addition of user commands.

### BACKGROUND OF THE INVENTION

A command line interface (CLI) is a variety of user interface that typically includes a prompt, such as “>”, after which a user may enter a command. The user Ienters a command by typing the command after the prompt and pressing the enter key. Many early operating systems for personal computers included such a CLI. To use a CLI, the user must be familiar with the available commands. In addition, the user must know the proper syntax for typing in the commands. Many commands may include options (such as parameters or optional features) that accompany the command. Hence, the user must know the proper commands, as well as be familiar with the options associated with the commands.

A graphical user interface (GUI) is a variety of user interface wherein graphical user interface elements are displayed and may be manipulated by a user to execute selected actions. The user operates a pointing device, such as a mouse, to bring about the selected actions. GUI's are typically more user friendly than CLI's. The graphical elements, such as menus, are typically constructed to provide interactive information regarding the activities that may be initiated by manipulating the graphical elements. However, GUI's may be cumbersome to users because they may require that a series of tasks be performed to initiate a single command. For example, a user may have to navigate multiple cascading menus to select a single desired action.

One difficulty with a traditional CLI is that it is static. In other words, the commands that can be accommodated by the CLI are fixed and cannot be readily modified.

### SUMMARY OF THE INVENTION

There is a need for a CLI session tool that will work with web-based applications, have a pre-defined set of base commands, and allow a user to dynamically add their own commands to the CLI session tool. The present invention is directed toward further solutions to address these needs.

In accordance with one example embodiment of the present invention, in an electronic server device in communication with a network, a method is provided for interacting with an application. The method includes receiving a request for information from a command line interface client. The request is mapped to a server side component, such as an instance of an object class, e.g., an action class. The action class instance performs processing to respond to the request from the command line interface client. The action class instance then instructs a controller servlet to construct an outgoing user interface. The outgoing user interface is constructed and the response to the request sent to the command line interface client, such that the command line interface client can present a user with the response, if desired.

In accordance with another embodiment of the present invention, the step of receiving a request includes receiving an interface command from the command line interface client, where the interface command is one of a predetermined set of interface commands. The step of receiving a request can also include receiving an interface command from the command line interface client, where the interface command is an interface command provided by the command line interface client.

In accordance with one aspect of the present invention, the step of mapping includes the controller servlet mapping the request to the action class instance.

In accordance with yet another aspect of the present invention, the step of the action class instance querying the application or server includes the action class instance pushing results of the request into a context accessible for constructing the user interface.

In accordance with still another aspect of the present invention, the step of the action class instance instructing the controller servlet includes selecting a server page corresponding to the language of the command line interface client request.

In accordance with one embodiment of the present invention, the request relates to a list of registered applications.

In accordance with another embodiment of the present invention, in an electronic client device, a method is provided for interacting with a server. The method includes sending a request from a command line interface. A response to the request is received at the command line interface client, such that the command line interface client can present a user with the response.

The method can further include the step of automatically downloading commands from the server upon connection with the server.

In accordance with another embodiment of the present invention, a computer readable medium containing a command line interface tool includes a predetermined set of commands for executing paths. A protocol for automatic connection with a remote session and management of such connection, including downloading of commands from a server of the remote session, is also provided. The interface tool can enable a user to add new interface commands to the interface tool, and remotely execute the new interface commands.

### BRIEF DESCRIPTION OF THE DRAWINGS

The aforementioned features and advantages, and other features and aspects of the present invention, will become better understood with regard to the following description and accompanying drawings, wherein:

FIG. 1 is a diagrammatic illustration of the structure of a CLI interacting with a server in accordance with one aspect of the present invention;

FIG. 2 is a flowchart illustrating a CLI interacting with a server in accordance with another aspect of the present invention;

FIG. 3 is a flowchart illustrating the CLI request for information in accordance with still another aspect of the present invention;

FIG. 4 is a diagrammatic illustration of the structure of a CLI dynamically interacting with a server in accordance with yet another aspect of the present invention; and

FIG. 5 is a flowchart illustrating a CLI dynamically interacting with a server in accordance with still another aspect of the present invention.

### DETAILED DESCRIPTION

An illustrative embodiment of the present invention relates to a CLI session tool that provides a minimal set of base commands and that allows a user to dynamically add their own commands to the CLI session tool. The CLI session tool is responsible for connecting to, and managing, some remote session, such that the commands can be executed within the context of the CLI tool to perform operations remotely. In addition, when a new command is added, the CLI session tool enables clients to locate and learn the new commands. The ability of the CLI session tool to download commands dynamically from whichever server it is connected eliminates the need to manually install a new command on every client.

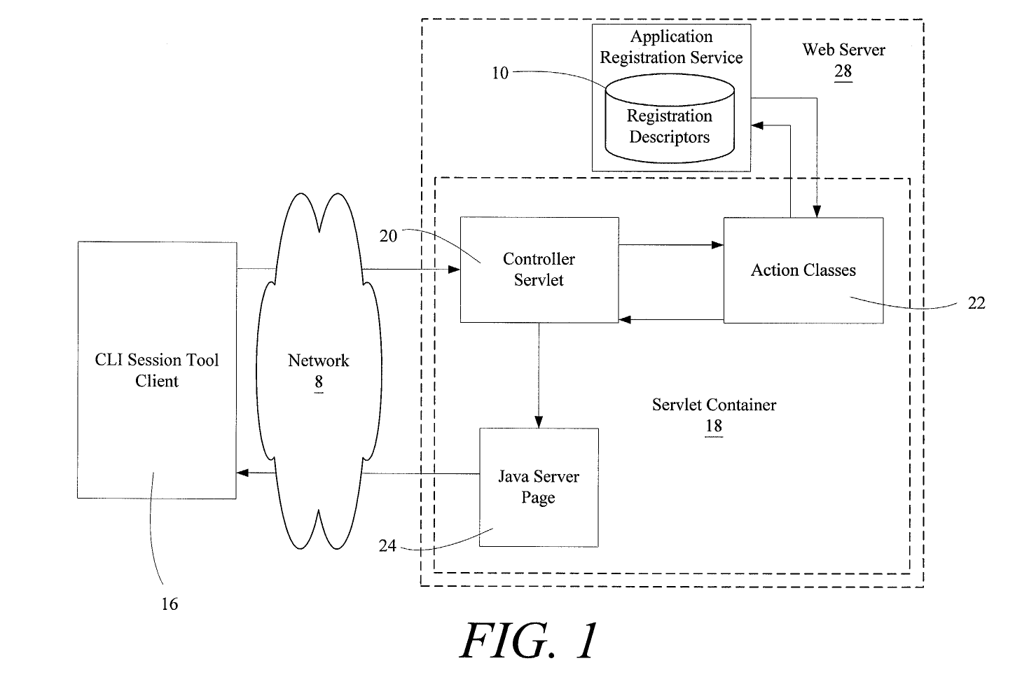

FIGS. 1 through 5, wherein like parts are designated by like reference numerals throughout, illustrate example embodiments of a CLI session tool according to the teachings of the present invention. Although the present invention will be described with reference to the example embodiments illustrated in the figures, it should be understood that many alternative forms can embody the present invention. One of ordinary skill in the art will additionally appreciate different ways to alter the parameters of the embodiments disclosed, in a manner still in keeping with the spirit and scope of the present invention.

FIG. 1 illustrates an environment suitable for practicing an illustrative embodiment of the present invention. A CLI session tool client 16 interacts with a management application that is running on a web server 28. The CLI session tool client 16 is a program that calls methods of specific objects when given a command in response to a command line prompt. The CLI session tool client 16 can execute a predetermined set of commands, or user defined plug-in commands. Either form of command can result in the execution of scripts, application programs, or other programs. The CLI session tool client 16 has the ability to execute batches of commands passed as arguments. Alternatively, input can be piped into the CLI session tool client 16 after being invoked. Further, the CLI session tool client 16 can be invoked, and passed a name of a file containing a plurality of commands therein.

The management application is a web-based application responsible for managing items in a network environment. The management application may, for example, manage components of a storage area network (SAN). The management application is implemented in the illustrated embodiment as a servlet container 18. The CLI session tool client 16 can take a number of different forms, but as used herein is a JAVA client that can be started from a shell script (i.e., a UNIX shell program or a Windows batch file). JAVA is a trademark and/or registered trademark of Sun Microsystems, Inc. of Mountain View, Calif., in the United States and in other countries.

The CLI session tool client 16 can communicate with multiple applications on the web server 28. Each application has a servlet container, such as servlet container 18. The CLI session tool client 16 gains access to the application servlet container 18 through a network 8 connection. The network 8 may be, but is not limited to, a packet switching network. For illustrative purposes herein, it is presumed that communications between the CLI session tool client 16 and the application servlet container 18 on the web server 28 are by way of hypertext transfer protocol (HTTP) messages. HTTP is a request/response protocol where clients submit requests to a server that generates a response.

The application servlet container 18 includes a controller servlet 20 that is responsible for the intake of requests and subsequent mapping of the requests to the appropriate destinations within the application servlet container 18. Object classes in the form of, for example, action classes 22 are designed to handle the HTTP requests received by the controller servlet 20. It should be noted that although the term “action class” is utilized herein, the term is intended to be synonymous with “server side components”, including action classes, servlets, JAVA server pages (JSPs), and the like. The embodiments described herein use the term “action classes” as specific examples of the invention. However, the CLI session tool of the present invention should not be limited to the specific embodiments described herein.

The action classes 22 have a relationship with the HTTP requests, such that an action class 22 is provided for each variety of HTTP request. The action classes can take the form of, or make use of, JAVABEANS. JAVABEANS are predefined reusable classes that can be used as components in building a larger function, process, or application. JAVABEANS receive a desired form of input or instruction, and carry out a predetermined action. JAVABEANS is a trademark and/or registered trademark of Sun Microsystems, Inc. of Mountain View, Calif., in the United States and in other countries

A server page, such as a JSP 24, receives results from the action classes 22 and constructs a user interface for communication with the particular client. In one example of a CLI client interacting with a server, the CLI session tool client 16 submits a request to the application servlet container 18. The application servlet container 18 passes the request on to an action class 22, which in turn performs a predetermined task, including referencing an application registration service 10. The application registration service 10 enables the management application to be employed with multiple plug-in web-based applications. As a result, a single management application may provide core services to multiple plug-in applications. The application registration service 10 is responsible for registering plug-in applications with the management application. The application registration service 10 is also responsible for creating in-memory representations of registered applications from the registration descriptors. The plug-in applications provide additional functionality to the management application, or embellish the functionality that is provided by the management application. One or more plug-in applications may be registered with the management application via the application registration service 10. Web pages for the management application and the plug-in applications may be stored for access by the web server 28. The web pages may include JSPs, which encapsulate scriptlets written in the JAVA programming language, and more traditional web page content. The logic that generates content for the page may be encapsulated within the scriptlets or within separate JAVABEANS. The application registration service 10 acts as a mechanism for the management application to advertise its core services to plug-in applications.

The device on which the CLI session tool client 16 runs can take many forms. The device can be, for example, a computer, a workstation, an internet appliance, a personal digital assistant (PDA), an intelligent pager, a set-top box, a wireless communication device, or other variety of electronic device that supports HTTP.

A response to the HTTP request is provided by either the management application, or in cooperation with one of the plug-in applications. The response is returned over the network 8 to the CLI session tool client 16. Further detail concerning the execution of management applications with web browsers can be found in corresponding patent application Ser. No. ______ (Docket SMQ-083) previously incorporated by reference.

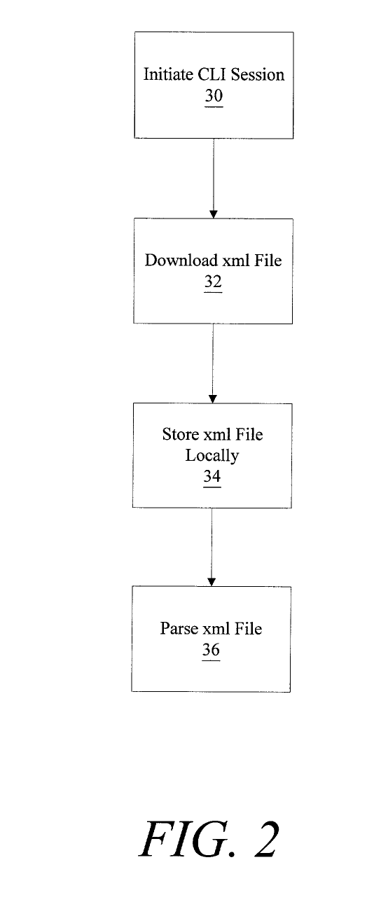

FIG. 2 is a flowchart that shows steps performed during an exemplary CLI session. The commands available to the user can all be executed from within the CLI session tool. Sub-commands existing within one main CLI session tool allow new commands to be added to the server and perform the necessary actions for the new commands to be propagated to the clients. This avoids the need for a developer to separately update all of the clients when a new command is added. In addition, maintenance actions such as bug fixes, patches, new enhancements, and the like, all can be done at the server, and any client connecting to the server benefits from the modification.

The CLI session is first initiated (step 30) through activation of a shell script, and the CLI session tool client 16 establishes a connection to the web server 28. After the CLI session tool client 16 establishes the connection to the server, the CLI session tool client 16 can download extensible markup language (XML) data (step 32). The CLI session tool client 16 then stores the XML data locally (step 34) containing all the registered CLI information. This information can be, for example, the list of supporting commands that can be executed within the CLI session. The list of supporting commands is formed of an initial list of predefined commands resident with the original server. In addition, clients and users can add CLI commands that can be executed with the CLI sessions. User and client entered CLI commands can originate with the particular user or client contacting the server, or with another remote user or client, in which case the new CLI command is introduced to the user or client accessing the server. The storage and updates to the XML data containing the registered CLI information can occur each time a session is initiated, on a predetermined periodic basis, or upon an indication that updates to the registered CLI information are available. It should further be noted that the protocol used does not need to be XML, but can be of a number of different markup or other languages, as long as they are compatible with the client and server.

The XML data is stored locally so that if a user has previously connected with the server, the user can obtain a help listing or help menu without having to first establish a connection to the server. The XML data from a previous connection remains in local storage for such instances. Periodic remote connections to the server must occur for the updates to the XML data to be carried out

After the XML data is stored locally, the XML data is parsed (step 36) to decipher the information pertaining to the CLI session. A command can be provided with the CLI session tool to allow for the explicit updating of the XML data by making a connection to the server, downloading the XML data, and then closing the connection to the server. The update command can be one of a predetermined set of commands originating with the CLI session tool, or can be one provided or modified by a user.

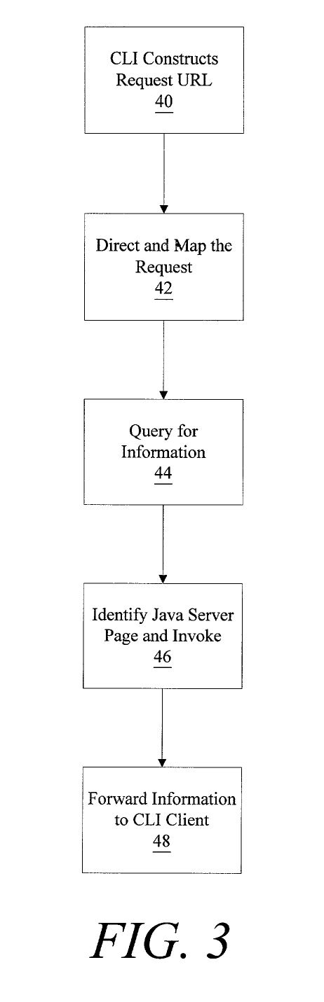

In accordance with one example embodiment of the use of CLI session tool with a server and corresponding application servlet container 18, FIG. 3 illustrates a flowchart depicting the CLI session tool client 16 interacting with an application registration service. The registration service is responsible for listing the applications that are available to the CLI session tool client 16 in communication with the application servlet container 18. The structure of this interaction is also illustrated in FIG. 1.

In this instance, the CLI session tool client 16 attempts to get information about applications registered with the registration service. The CLI session tool 16 issues an HTTP request that ultimately results in a presentation layer JAVA server page, such as the JAVA server page 24, sending back a plain text stream containing the names of the registered applications as desired. One of ordinary skill in the art will understand and appreciate that other information can be obtained using the interaction process as described herein.

The sequence of events for a CLI client, such as the CLI session tool client 16, interacting with an application or database, such as the application registration service on the server, is exemplified as follows. Prior to the CLI client's request, the application registration service 10 exists as an integral part of the management application. The application registration service 10 populates itself using parsed contents of XML application descriptors. It results in a listing of all registered applications. The CLI session tool client 16 constructs a request URL based on a combination of user input and downloaded XML data (step 40). This request URL can potentially contain a set of parameters that dictate how presentation layer components may craft a response. The request URL is used to direct where the request goes. The request can go either to the controller servlet 20 if the CLI command is one of a number predetermined commands, or directly to the proper registered application for user defined CLI commands (step 42). In either instance, the request ends up at a controller servlet that maps the incoming request to an instance of an action class, such as the action classes 22. The action classes 22, for example, JAVABEANS action classes, query the application registration service for the information requested by the CLI session tool client 16 (step 44). This step includes the action classes 22 pushing the results of the request into a context that is accessible to JAVA server pages, which will construct the actual client interface. The instance of the action classes 22 instructs the controller servlet 20 as to which JAVA server page should construct the outgoing user interface, and further instructs the instance of the action classes 22 to execute the construction of the outgoing user interface (step 46).

The selection of the JAVA server page is typically carried out in accordance with the particular CLI session tool client 16 making the request. In the example instance, the JAVA server page 24 sends back an appropriately encrypted plain text stream containing the information requested.

The information is forwarded to the CLI session tool client 16 (step 48). The CLI session tool client 16 can then present the user with a list of registered applications.

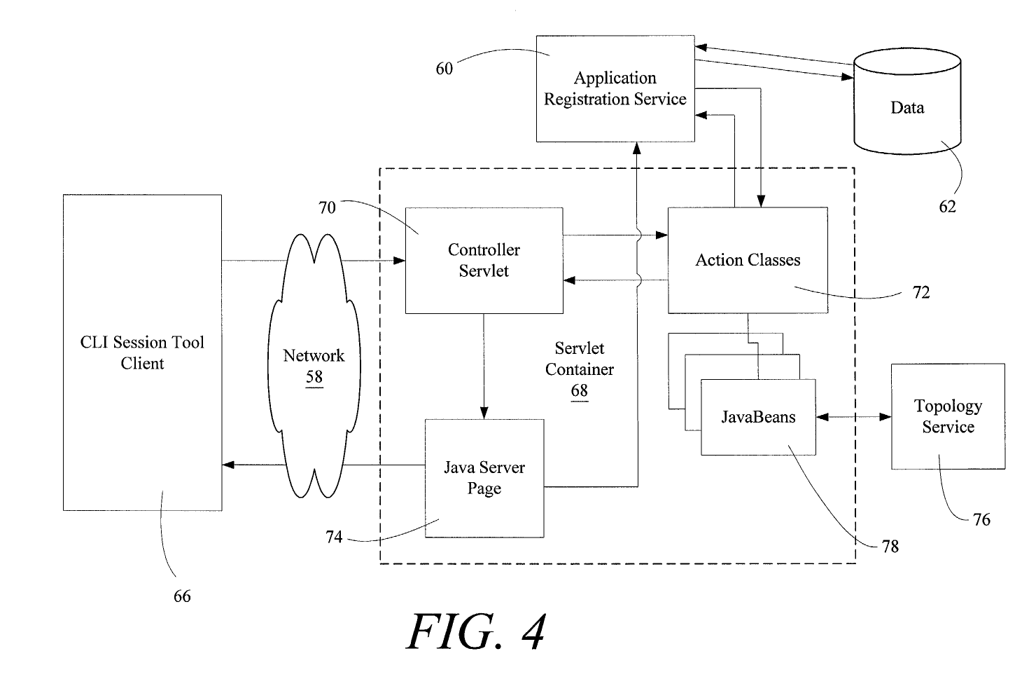

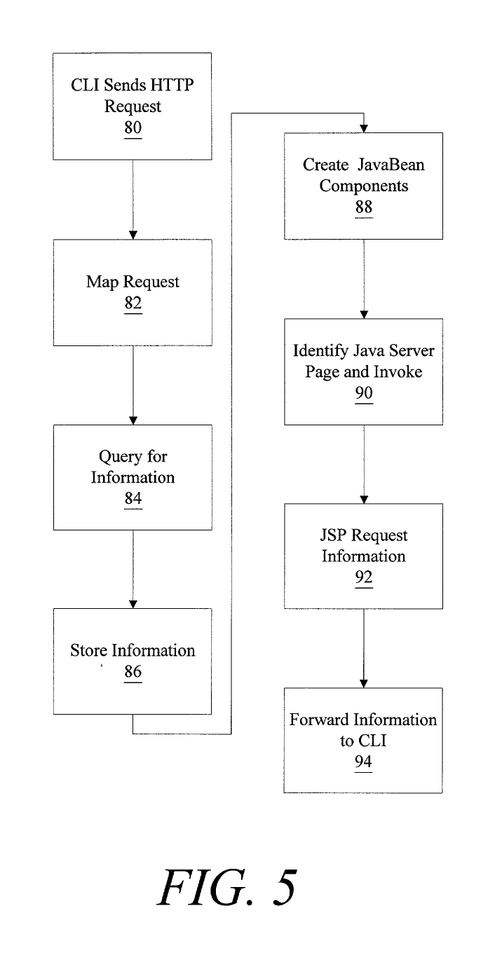

FIGS. 4 and 5 illustrate the construction of dynamic user interfaces from application registration service information. One desirable feature of plug-in architecture is that a user be able to manage elements in a storage area network with the appropriate management application. FIG. 4 illustrates a diagram of a structure for an environment likely to be generated by a client request. A CLI Session Tool Client 66 in communication with a servlet container 68 via a network 58 may include interactions with a controller servlet 70, action classes 72, and a JAVA server page 74. The action classes 72 maintain access to an application registration service 60, which can further communicate with an additional database 62 if necessary. A topology service 76 can also provide information to the action classes 72.

In operation as shown in FIG. 5, first the application registration service is in existence and populated prior to the CLI session tool client 66 request. The CLI session tool client 66 issues an HTTP request for storage area network information (step 80). The controller servlet 70 forwards the request to an appropriate instance of the action classes 72 (step 82). The instance of the action classes 72 could retrieve some information from the topology service 76 and potentially store some or all of the information in one of the servlet contexts (request, application, and the like) (step 84 and step 86). JAVABEANS components 78 are created and pushed into a servlet context (step 88). The created JAVABEANS components 78 can interact with the topology service 76 to gather the information about the objects in the storage area network.

The instance of the action classes 72 identifies the JAVA server page 74 and instructs the controller servlets 70 how the request should be forwarded (step 90). The request is forwarded to the JAVA server page 74 that constructs the user interface to be pushed to the CLI session tool client 66 (step 92). The JAVA server page then requests data from the JAVABEANS components to build the presentation layer and also interacts with the application registration service to ascertain which applications should be associated with a given graphical node. This information is forwarded to CLI session tool client 66 (step 94). Thus, the dynamic construction of user interface from application registration service information is complete.

The CLI session tool of the present invention is provided with a base set of commands for interfacing with an operating system. The CLI session tool is responsible for remote session connection and maintenance of connection. The tool allows users to add new commands to the tool/session dynamically, so that new commands can be operated remotely. The new commands typically have a similar format to the predetermined base set of commands. The tool is HTTP-based so that it can work in conjunction with browser based applications, including being able to function in environments from wide-area-networks to handheld PDAs. The tool can download commands dynamically from whichever server it is connected, thus freeing up the user from having to manually install a new command on every client.

Numerous modifications and alternative embodiments of the present invention will be apparent to those skilled in the art in view of the foregoing description. Accordingly, this description is to be construed as illustrative only and is for the purpose of teaching those skilled in the art the best mode for carrying out the present invention. Details of the structure may vary substantially without departing from the spirit of the present invention, and exclusive use of all modifications that come within the scope of the appended claims is reserved. It is intended that the present invention be limited only to the extent required by the appended claims and the applicable rules of law.

What is claimed is:

1. In an electronic server device in communication with a network, a method for interacting with a client, comprising the steps of:
downloading a file containing CLI registration information to the client; and
receiving at least one update from the client containing at least one client originating CLI command.

2. The method of claim 1, further comprising storing the at least one client originating CLI command.

3. The method of claim 1, wherein the update comprises at least one update file.

4. The method of claim 3, further comprising downloading the at least one update file containing at least one client originating CLI command to a second client.

5. The method of claim 3, wherein the file and the at least one update file are XML files.

6. In an electronic device in communication with a network, a method for interacting with a server, comprising the steps of:
receiving a file containing CLI registration information from the server;
storing the file; and
parsing the file to decipher information pertaining to CLI commands.

7. The method of claim 1, further comprising establishing an update file containing at least one client originating command.

8. The method of claim 7, further comprising sending the update file containing at least one client originating CLI command to the server.

9. The method of claim 1, further comprising receiving an additional filed containing CLI registration information comprising a new CLI command from a distinct client.

10. In an electronic server device in communication with a network, a method for interacting with a database, comprising the steps of:
receiving a request from a command line interface client;
mapping the request to an instance of an object class;
the object class instance querying the database to respond to the request;
the object class instance instructing the construction of an outgoing user interface; and
constructing the outgoing user interface and sending a response to the request to the command line interface client.

11. The method of claim 10, wherein the step of receiving a request comprises receiving an interface command from the command line interface client, the interface command being one of a predetermined set of interface commands.

12. The method of claim 10, wherein the step of receiving a request comprises receiving an interface command from the command line interface client, the interface command being an interface command provided by the command line interface client.

13. The method of claim 10, wherein the step of mapping comprises the controller servlet mapping the request to the object class instance.

14. The method of claim 10, wherein the step of the object class instance querying the registration service comprises the object class instance pushing results of the request into a context accessible by a server page for constructing the user interface.

15. The method of claim 10, wherein the step of instruction the construction of an outgoing user interface comprises a selection of a server page corresponding to the language of the command line interface client request.

16. The method of claim 10, wherein the request relates to a list of registered applications.

17. The method of claim 10, wherein the database comprises a registration service.

18. In an electronic client device, a method for interacting with a server, comprising the steps of:
sending a request from a command line interface of a command line interface client to a server; and
receiving a response to the request at the command line interface client, such that the command line interface client can present a user with the response;
wherein the command line interface client utilizes at least one of commands originating at the client and commands originating at the server.

19. The method of claim 18, further comprising the step of automatically downloading commands from the server upon connection with the server.

20. The method of claim 18, wherein the server includes an application registration service.

21. A computer readable medium containing an HTTP based software command line interface tool, comprising:
a predetermined set of commands for executing tasks; and
a protocol for automatic connection with a remote session and management of such connection, including downloading of commands from a server of the remote session;
wherein the interface tool enables a client to add new interface commands to the interface tool and remotely execute the new interface commands.

22. A computer readable medium containing a software tool for executing a method in an electronic server device in communication with a network for interacting with a client, the method comprising the steps of:
downloading a file containing CLI registration information to the client; and
receiving at least one update from the client containing at least one client originating CLI command.

23. A computer readable medium containing a software tool for executing a method in an electronic server device in communication with a network for interacting with a database, the method comprising the steps of:
receiving a request from a command line interface client;
mapping the request to an instance of an object class;
the object class instance querying the database to respond to the request;
the object class instance instructing the construction of an outgoing user interface; and
constructing the outgoing user interface and sending a response to the request to the command line interface client.

24. A computer readable medium containing a software tool for executing a method in an electronic client device for interacting with a server, the method comprising the steps of:
sending a request from a command line interface of a command line interface client to a server; and
receiving a response to the request at the command line interface client, such that the command line interface client can present a user with the response;
wherein the command line interface client utilizes at least one of commands originating at the client and commands originating at the server.
